(19) United States
(12) Patent Application Publication
(10) Pub. No.: US 2008/0077650 A1
(43) Pub. Date: Mar. 27, 2008

(54) Method and apparatus for transferring data between a home networked device and a storage system

(76) Inventor: Matthew A. Jared, Hillsboro, OR (US)

Correspondence Address: INTEL CORPORATION;c/o INTELLEVATE, LLC, P.O. BOX 52050, MINNEAPOLIS, MN, 55402, US

(21) Appl. No.: 11/512,795

(22) Filed: Aug. 29, 2006

(51) Int. Cl. G06F 15/16

(52) U.S. Cl. 709/203

(57) ABSTRACT

A method and apparatus is provided for transferring data between a device accessible via a home network and a storage system. The storage system advertises storage services to the device over the home network. The device issues a request to the storage service to download the data to the storage system by transmitting the data to the storage system over the home network using a storage protocol.

### FIELD

This disclosure relates to home networking and in particular to providing access to a storage system over a home network.

### BACKGROUND

A home network is a residential local area network, that is, a computer network covering a small local area, such as a home or office. A home network may include personal computers such as laptops (mobile computers) and home media devices such as Digital Video Recorders (DVRs) like TiVO, digital audio players and Internet-ready stereo systems. The personal computers and home media devices may communicate over telephone wiring, power distribution wires, a wired network such as Ethernet or a wireless network. For example, Home Phoneline Networking Alliance (HomePNA) allows computers to be networked using telephone wiring and Power Line Communication (PLC) (also called Mains Communication, Power Line Telecoms (PLT), Powerband or Power Line Networking (PLN)) such as HomePlug allows computers to be networked over power distribution wires.

In order to store data from a first personal computer to a second personal computer system connected to the home network, one method is to first copy the data to a removable storage medium such as a Compact Disk (CD)/Digital Video Disk (DVD) on the first personal computer and then physically move the removable storage medium to the second personal computer system. Another method is to set up a network share on a user accessible network between the first and second personal computer systems. However, neither of these methods allows a device or appliance which does not have a user accessible network or a removable storage media interface to store data on a central storage system or device over the home network.

### BRIEF DESCRIPTION OF THE DRAWINGS

Features of embodiments of the claimed subject matter will become apparent as the following detailed description proceeds, and upon reference to the drawings, in which like numerals depict like parts, and in which:

FIG. 1 is a block diagram of a system having a plurality of devices that may communicate over a home network;

FIG. 2 illustrates an embodiment of a flow of messages passed over a home network between a UPnP control point and a UPnP device to store data in the storage device according to the principles of the present invention; and

FIG. 3 is a block diagram of an embodiment of a system that includes the server shown in FIG. 1 that allows data stored in a device coupled to a home network to be stored in a storage system;.

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined only as set forth in the accompanying claims.

### DETAILED DESCRIPTION

The Universal Plug and Play (UPnP) forum is an industry initiative designed to enable simple and robust connectivity among stand-alone devices and personal computers from many different vendors. UPnP technology may be used to control networked devices in a home by enabling devices to offer up their services through an entry point referred to as an “UPnP Device”. These services can be accessed by devices (hardware or software) through an “UPnP Control Point”.

Instead of using conventional methods like copying to a Compact Disk (CD)/Digital Video Disk (DVD) and then physically moving the data stored on the CD/DVD to a storage system or setting up network share between two computer systems, data can be transferred directly from the storage device over the UPnP network (home network) through an interface to another storage device which may be coupled to a storage network. This allows a device which may be a consumer device such as a personal computer or an appliance or home media device which does not have a user accessible network or removable storage media interface to offload data to a central storage system or a storage device coupled to a storage network. The central storage system also provides a mechanism to store large amounts of data for easy access over a home network.

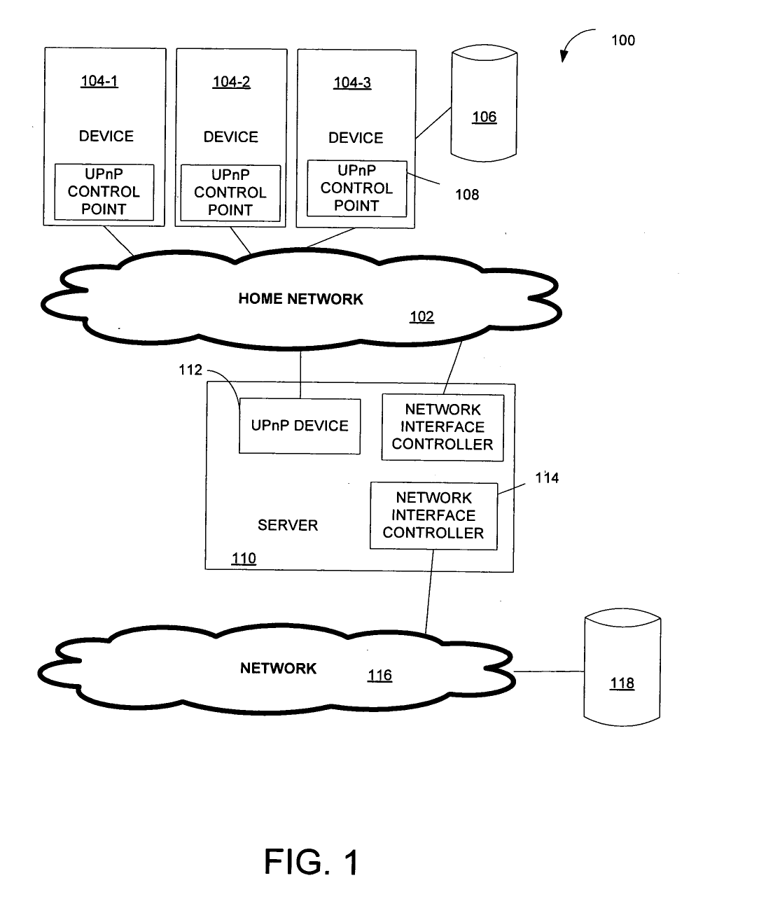

FIG. 1 is a block diagram of a system 100 having a plurality of devices that may communicate over a home network 102. The home network is any communications medium that allows communication between devices. The home network may use telephone wiring, power distribution wires, a wired network such as Ethernet or may be a wireless network. For example, the Home Phoneline Networking Alliance (HomePNA) allows computers to be networked using telephone wiring and Power Line Communication (PLC) (also called Mains Communication, Power Line Telecoms (PLT), Powerband or Power Line Networking (PLN)) such as HomePlug allows computers to be networked over power distribution wires. The devices that communicate over the home network may include personal computers such as laptops (mobile computers) and desktop computers, home media devices such as Digital Video Recorders (DVRS) like TiVO, digital audio players and Internet-ready stereo systems, Personal Digital Assistants (PDAs), Entertainment Personal computers (EPC) and an Intel VIIV system.

The Universal Plug and Play (UPnP) forum defines device control protocols built upon Internet-based communication standards that allows peer-to-peer network connectivity of personal computers, intelligent devices (appliances) and wireless devices. UPnP technology can run on any physical networking medium including wired (telephone lines, power lines using the Power Line Communication (PLC protocol) and Ethernet) and wireless. UPNP technology makes home networking simple and affordable by enabling devices to offer up their services through an entry point referred to as an “UPnP Device” 112. These services can be accessed by devices (hardware or software) through an “UPnP Control Point” 108.

Each of the plurality of devices 104-1, 104-2, 104-3 coupled to home network 102 includes a respective UPnP control point 108. A server 110 is also coupled to the home network 102 and includes an UPnP device 112 that provides storage services that can be accessed by the plurality of devices 104-1, 104-2, 104-3 through a respective UPnP control point 108. The storage services provided by the UPnP control point 108 may access a storage device 118 that may be coupled to another network 116 which may use the Ethernet protocol.

The storage device 118 may be a disk drive such as, a hard disk drive or a floppy disk drive, Digital Video Disk (DVD) drive, compact disk (CD) drive, Redundant Array of Independent Disks (RAID), or tape drive.

The server 110 and its associated storage device 118 may be referred to as a central storage system. In the embodiment shown, the central storage system includes a network interface 114 that communicates with at least one storage device using the Internet Small Computer System Interface (iSCSI) protocol. Transmission Control Protocol (TCP)/Internet Protocol (IP) packets may be transmitted between devices 104-1, 104-2, 104-3 and server 110 over the home network.

The Small Computer Systems Interface (SCSI) is a protocol for communicating with various Input/Output devices such as hard disk drives and removable storage devices. The iSCSI protocol specifies a method for encapsulating SCSI commands in the Transport Control Protocol (TCP)/Internet Protocol (IP) allowing any TCP/IP network to carry storage traffic. iSCSI enables efficient and high performing transmission of data from one network node to another. A version of the iSCSI protocol is described in “Internet Small Computer System Interface”, Request for Comments (RFC) 3720 available from the Internet Engineering Task Force (IETF) at www.ietf.org (hereinafter termed the “iSCSI standard”). A version of the SCSI protocol for block-oriented direct-access devices such as magnetic disk drives is described in American National Standards Institute (ANSI) INCITS 351-2001 “SCSI Primary Commands-2 (SPC-2) and ANSI INCITS 405-2005” SCSI Block Commands-2 (SBC-2). ISCSI encapsulates the SCSI protocol in an Internet Protocol (IP) packet that is transmitted using the IP protocol over the network.

A consumer device 104-3, for example, a personal computer coupled to the home network 102 may include a storage device 106 in which all storage capacity is used. For example, the storage device 106 may store video and audio files which consume large amounts of storage capacity.

Using the iSCSI protocol, data such as video and audio data may be transferred across a network to a network-enabled storage device, or Storage Area Network (SAN). The UPnP Device 112 in the server 110 provides all of the interfaces necessary to send data over the iSCSI network 116 to storage device 118 which is iSCSI-enabled.

Data may be transferred between storage devices 118, 106 or between memory in any of devices 104-1, 104-2, 104-3 and storage device 118. For example, device 104-1 may be a PDA that stores files in memory.

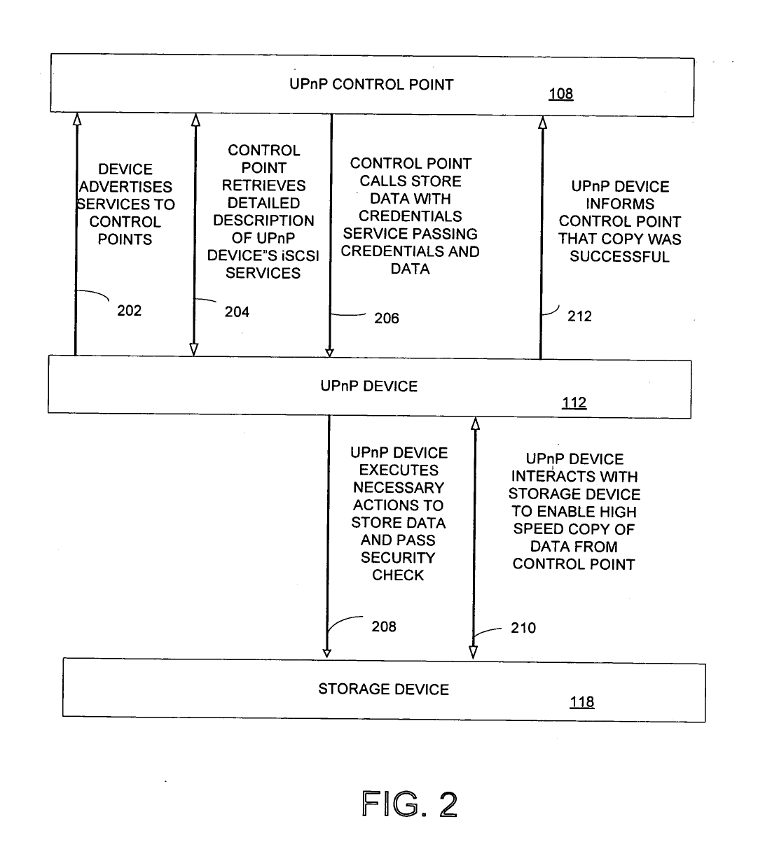

FIG. 2 illustrates an embodiment of a flow of messages passed over a home network 102 between an UPnP control point 108 and an UPnP device 112 to store data in the storage device according to the principles of the present invention.

The UPnP architecture uses Transport Communications Protocol/Internet Protocol (TCP/IP) and HyperText Transport Transfer Protocol (HTTP) to control and transfer data among networked devices. A version of the UPnP device architecture is discussed in “UPnP Device Architecture”, Version 1.0, Jun. 8, 2000 available at www.upnp.org When a UPnP device 112 is first connected to a network, it checks to see if the network is managed. If the network is managed, the UPnP device 112 is assigned an IP address. If the network is not managed, the UPnP device 112 intelligently chooses an IP address from a set of reserved addresses.

Having obtained an IP address, at 200, the UPnP device 112 advertises its services to UPnP control points 108 on the network 102 using a discovery message that includes information about the UPnP device 112 and its services. At 202, after the control point 108 has discovered an UPnP device 112, the UPnP control point 108 retrieves a description of the UPnP device 112. At 204, after the UPnP control point 108 has retrieved a description of the UPnP device 112, the UPnP control point 108 can send actions to an UPnP device's services.

Table 1 below illustrates an embodiment of a description for an UPnP device that advertises a storage service. The UPnP control point 108 retrieves the description from the Uniform Resource Locator (URL) provided by the UPnP device 112 in the discovery message. The UPnP description is expressed in Extensible Markup Language (XML) and includes vendor-specific information such as model name and number, serial number and manufacturer name. The description also includes URLs for control and listings for all services. Using the URL, the UPnP control point 108 retrieves this description of the UPnP device 112 and its capabilities from the URL provided by the UPnP device 112 in the discovery message.

```
TABLE 1
  <?xml version=“1.0” ?>
<root xmlns=“urn:schemas-upnp-org:device-1-0”>
<specVersion>
  <major>1</major>
  <minor>0</minor>
  </specVersion>
  <URLBase>TBD</URLBase>
<device>
  <deviceType>urn:schemas-upnp-org:device:iSCSIStorageInterface:
  1</deviceType>
  <friendlyName>iSCSIStorageInterface</friendlyName>
  <manufacturer>Intel</manufacturer>
  <manufacturerURL>TBD</manufacturerURL>
  <modelDescription>UPnP Interface to ISCSI Storage
  Device</modelDescription>
  <modelName>TBD</modelName>
  <modelNumber>TBD</modelNumber>
  <modelURL>TBD</modelURL>
  <serialNumber>TBD</serialNumber>
  <UDN>TBD</UDN>
  <UPC>TBD</UPC>
- <iconList>
- <icon>
  <mimetype>TBD</mimetype>
  <width>TBD</width>
  <height>TBD</height>
  <depth>TBD</depth>
  <url>TBD</url>
  </icon>
  TBD
  </iconList>
<serviceList>
<service>
  <serviceType>urn:schemas-upnp-
    org:service:iSCSIStorageInterfaceStoreData:1</serviceType>
  <serviceId>urn:upnp-org:serviceId:iSCSIStorageInterfaceStoreData</
  serviceId>
  :
  <SCPDURL>TBD</SCPDURL>
  <controlURL>TBD</controlURL>
  <eventSubURL>TBD</eventSubURL>
  </service>
  :
  </service>
  </serviceList>
  <deviceList>TBD</deviceList>
  <presentationURL>TBD</presentationURL>
  </device>
```

In the embodiment of the description shown in Table 1, the UPnP device 112 advertises a storage service for storing data. The advertised storage service has a Service Type of “iSCSIStoragelnterfaceStoreData” and a ServiceID of “iSCSIStorageInterfaceStoreData. In other embodiments, other storage services may be provided including store data with credentials; encrypt and store data; encrypt and store data with credentials; compress and store data; compress and store data with credentials; and retrieve files (restore, search and retrieve, etc.) from the server.

The list of services begins after the <servicelist>. The subelement <service>is repeated once for each service. The <SCDPDURL> provides the URL for the service description. Each service description includes a list of commands, or actions that the service responds to and parameters or arguments for each action. To retrieve an UPnP description, the control point 108 issues a HyperText Transfer Protocol (HTTP) GET request on the URL in the discovery message and the UPnP device 112 returns the device description. A service description is retrieved using a URL within the device description.

The UPnP description for a service defines actions and their arguments, and state variables and their data type, range and event characteristics. An example of an UPnP description for an “iSCSIStoragelnterfaceStoreDataWithCredentials” service is shown below in Table 2.

TABLE 2

```
    <?xml version=“1.0” ?>
<scpd xmlns=“urn:schemas-upnp-org:service-1-0”>
<specVersion>
  <major>1</major>
  <minor>0</minor>
  </specVersion>
<actionList>
<action>
  <name>StoreData</name>
<argumentList>
<argument>
  <name>Data</name>
  <direction>in</direction>
  <retval />
  <relatedStateVariable>storedData</relatedStateVariable>
  </argument>
  </argumentList>
  </action>
<action>
  <name>SetUserName</name>
<argumentList>
<argument>
  <name>UserName</name>
  <direction>in</direction>
  <retval />
  <relatedStateVariable>userName</relatedStateVariable>
  </argument>
  </argumentList>
  </action>
<action>
  <name>SetPassword</name>
<argumentList>
<argument>
  <name>Password</name>
  <direction>in</direction>
  <retval />
  <relatedStateVariable>password</relatedStateVariable>
  </argument>
  </argumentList>
  </action>
  </actionList>
<serviceStateTable>
<stateVariable sendEvents=“no”>
  <name>storedData</name>
  <dataType>string</dataType>
  </stateVariable>
<stateVariable sendEvents=“no”>
  <name>userName</name>
  <dataType>string</dataType>
  </stateVariable>
  <stateVariable sendEvents=“no”>
  <name>password</name>
  <dataType>string</dataType>
  </stateVariable>
  </serviceStateTable>
  </scpd>
```

After the UPnP control point 108 has retrieved the description from the UPnP device 112 that includes the services advertised as being supported by the UPnP device, at 206, the UPnP control point 108 may send Simple Object Access Protocol (SOAP) messages to the UPnP Device 112 to perform any of the services. For example, the UPnP control point 108 may send a SOAP message to copy data from storage device 106 to storage device 118 over the home network 102. SOAP is an XML-based protocol that allows applications to exchange information over HyperText Transfer Protocol (HTTP). Table 3 below illustrates an embodiment of a SOAP message that may be sent from the UPnP control point 108 to the UPnP Device 112.

TABLE 3

```
POST path of control URL HTTP/1.1
HOST: host of control URL:port of control URL
CONTENT-LENGTH: bytes in body
CONTENT-TYPE: text/xml; charset=“utf-8”
SOAPACTION: “urn:schemas-upnp-
org:service:iSCSIStorageInterfaceStoreDataWithCredentials:
v#SetUserName”
<s:Envelope
  xmlns:s=“http://schemas.xmlsoap.org/soap/envelope/”
  s:encodingStyle=“http://schemas.xmlsoap.org/soap/encoding/”>
  <s:Body>
  <u:SetUserName xmlns:u=“urn:schemas-upnp-
org:service:iSCSIStorageInterfaceStoreDataWithCredentials:v”>
    <argumentName>UserName</argumentName>
  </u:actionName>
  </s:Body>
</s:Envelope>
```

Upon receiving the request for service from the UPnP control point 108, at 208, the UPnP device 112 executes the necessary action to initiate the storing of data in the storage device 118 using the iSCSI protocol over the home network 102, if the security check is successful.

At 210, the UPnP device 112 interacts with the storage device 118 to enable high speed copy of data over the home network 102 using the iSCSI protocol to copy data from the control point 108.

At 212, the UPnP device 112 sends a message to the UPnP control point 108 to inform the UPnP control point 108 that the copy was successful.

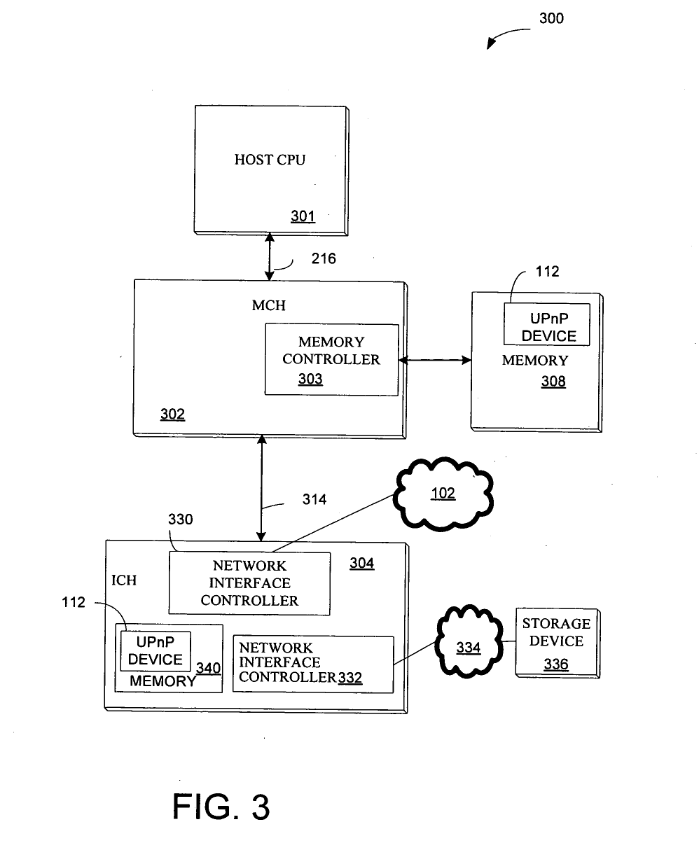

FIG. 3 is a block diagram of an embodiment of a system 300 that includes the server 110 shown in FIG. 1 that allows data stored in a device coupled to a home network to be stored in a storage system. The server 300 includes a Central Processing Unit (CPU) 301, a Memory Controller Hub (MCH) 302 and an 1/O Controller Hub (ICH) 304. The MCH 302 includes a memory controller 303 that controls communication between the CPU 301 and memory 308.

The Central Processing Unit (CPU) 301 may be any one of a plurality of processors such as a single core Intel® Pentium IV® processor, a single core Intel Celeron processor, an ® XScale processor or a multi-core processor such as Intel® Pentium D, Intel® Xeon® processor, or Intel® Core® Duo processor or other processor.

The memory 308 may be Dynamic Random Access Memory (DRAM), Static Random Access Memory (SRAM), Synchronized Dynamic Random Access Memory (SDRAM), Double Data Rate 2 (DDR2) RAM or Rambus Dynamic Random Access Memory (RDRAM) or any other type of memory.

The ICH 304 may be coupled to the MCH 302 using a high speed chip-to-chip interconnect 314 such as Direct Media Interface (DMI). DMI supports 2 Gigabit/second concurrent transfer rates via two unidirectional lanes. The CPU 301 and MCH 302 communicate over a system bus 316.

The ICH 304 also includes a network interface controller 332 for controlling communication over another network 334 to another storage device 336. In one embodiment the network 334 is an Ethernet network and the network interface controller 332 communicates with the storage device 336 using the Internet SCSI (iSCSI) protocol.

In one embodiment, the UPnP device 112 may be stored in memory 308 coupled to MCH 302. In another embodiment, the UPNP device 112 may be stored in memory 340 in the ICH 304, which may be non-volatile memory.

In one embodiment, the UPnP control point 108 is included in an application that executes on device 104-3. A user may initiate a backup of a file through a user interface on device 104-3 by selecting a “backup” button. The UPnP control point initiates the backup by requesting the advertised storage services through a SOAP message. The storage service performs the file backup by transferring the file using the iSCSI protocol over the home network.

In another embodiment, log files resulting from a daily backup may be moved to the storage system from a device 104-1, 104-2, 10403 by off-loading (copying) the log files to the storage system and subsequently deleting the log files stored on device 104-1, 104-2, 104-3 after receiving confirmation of successful completion of the offload operation.

An embodiment of the invention has been described for a storage device that includes an iSCSI interface. However, the invention is not limited to iSCSI, an embodiment of the invention may also be used for devices having other IP-based storage networking interfaces such as Fibre channel over IP (FCIP or FC/IP also known as Fibre Channel tunneling or storage tunneling) or Advanced Technology Attachment (ATA over Ethernet (AoE) which allows ATA devices to be accessed over Ethernet networks.

It will be apparent to those of ordinary skill in the art that methods involved in embodiments of the present invention may be embodied in a computer program product that includes a computer usable medium. For example, such a computer usable medium may consist of a read only memory device, such as a Compact Disk Read Only Memory (CD ROM) disk or conventional ROM devices, or a computer diskette, having a computer readable program code stored thereon.

While embodiments of the invention have been particularly shown and described with references to embodiments thereof, it will be understood by those skilled in the art that various changes in form and details may be made therein without departing from the scope of embodiments of the invention encompassed by the appended claims.

1. An apparatus comprising:
an interface to advertise a storage service available to a device over a network and to process a request for the storage service received from the device; and
a storage interface to perform the storage service for the device.

2. The apparatus of claim 1, wherein the interface is a universal plug and play (UPnP) device.

3. The apparatus of claim 2, wherein the storage service is advertised in an UPnP description.

4. The apparatus of claim 1, wherein the storage interface performs the storage service using the Internet Small computer systems interface (iSCSI) protocol.

5. The apparatus of claim 1, wherein the storage service is to download data from the device and to store the data in a storage device controlled by the storage interface.

6. The apparatus of claim 5, wherein the storage service to compress data prior to storing in a storage device.

7. The apparatus of claim 5, wherein the storage service to authenticate a requester of the storage service prior to storing data from the device in the storage device

8. A method comprising:
advertising a storage service available to a device over a network;
upon receiving a request for the advertised storage service from the device, performing the storage service for the device.

9. The method of claim 8, wherein the storage service is advertised by a universal plug and play (UPnP) device.

10. The method of claim 9, wherein the storage service is advertised in a universal plug and play (UPnP) description.

11. The method of claim 8, wherein the storage service is performed using the Internet Small computer systems interface (iSCSI) protocol.

12. The method of claim 8, wherein the storage service is to download data from the device and to store the data in a storage device controlled by the storage interface.

13. The method of claim 12, wherein the storage service to compress data prior to storing in a storage device.

14. The method of claim 12, wherein the storage service to authenticate a requester of the storage service prior to storing data from the device in the storage device

15. The method of claim 8, wherein the device is a personal computer.

16. The method of claim 8, wherein the storage service downloads data from a storage device in the device to another storage device.

17. An article including a machine-accessible medium having associated information, wherein the information, when accessed, results in a machine performing:
advertising a storage service available to a device over a network;
upon receiving a request for the advertised storage service from the device, performing the storage service for the device.

18. The article of claim 17, wherein the storage service is advertised by a universal plug and play (UPnP) device.

19. The article of claim 17, wherein the storage service is performed using the Internet Small computer systems interface (iSCSI) protocol.

20. A system comprising:
a hard disk drive; and
a storage controller, the storage controller comprising:
an interface to advertise a storage service available to a device over a network and to process a request for the storage service received from the device; and
a storage interface to perform the storage service for the device.

21. The system of claim 20, wherein the interface is a universal plug and play (UPnP) device.

22. The system of claim 20, wherein the storage interface performs the storage service using the Internet Small Computer Systems Interface (iSCSI) protocol.
